(19) United States
(12) Patent Application Publication
(10) Pub. No.: US 2015/0074178 A1
(43) Pub. Date: Mar. 12, 2015

(54) DISTRIBUTED PROCESSING METHOD

(71) Applicant: Samsung Electronics Co., Ltd., Suwon-si (KR)

(72) Inventors: Jae-Ki HONG, Suwon-si (KR); Woo-Seok CHANG, Seoul (KR)

(73) Assignee: Samsung Electronics Co., Ltd., Suwon-si (KR)

(21) Appl. No.: 14/450,603

(22) Filed: Aug. 4, 2014

(30) Foreign Application Priority Data
Sep. 11, 2013 (KR) 10-2013-0109221

(51) Int. Cl. H04L 29/06

(52) U.S. Cl. CPC H04L 67/42
USPC 709/203

(57) ABSTRACT

A distributed processing method and apparatus are provided. The distributed processing method includes receiving status information about a plurality of storages respectively provided in a plurality of slave nodes constituting a distributed cluster, and selecting at least one operation node, among the plurality of slave nodes, for performing at least one operation to be processed in the distributed cluster based on the status information.

### CROSS-REFERENCE TO RELATED APPLICATION

This application claims priority from Korean Patent Application No. 10-2013-0109221 filed on Sep. 11, 2013 in the Korean Intellectual Property Office, the disclosure of which is incorporated herein in its entirety by reference.

### BACKGROUND

1. Field

The present inventive concept relates to a distributed processing method and apparatus.

2. Description of the Related Art

Hadoop is a technology used in implementing distributed computing. Hadoop is an open-source framework including a Hadoop distributed file system (HDFS) for distributing and storing a large quantity of data and a MapReduce algorithm for distributing and processing the stored data.

A distributed cluster enabling distributed computing includes one or more master nodes and a plurality of slave nodes. In the distributed cluster, it is important to secure efficient distributed processing of data and stability of data.

Japanese patent laid-open publication No. 2013-088863 discloses a parallel distributed processing method and a parallel distributed processing system.

### SUMMARY

One or more exemplary embodiments of the present inventive concept provide a distributed processing method and apparatus for efficiently processing data while securing stability of data.

These and other objects of the present inventive concept will be described in or be apparent from the following description of the exemplary embodiments.

According to an aspect of an exemplary embodiment, there is provided a distributed processing method which may include: receiving status information about a plurality of storages respectively provided in a plurality of slave nodes constituting a distributed cluster, and selecting at least one operation node, among the plurality of slave nodes, for performing at least one operation to be processed in the distributed cluster based on the status information.

According to an aspect of another exemplary embodiment, there is provided a distributed processing method which may include: receiving status information about a plurality of nodes constituting a distributed cluster, the status information including at least one of an abrasion extent, a performance level and an error rate of the plurality of nodes; and selecting at least one node among the plurality of nodes for performing at least one operation to be processed in the distributed cluster based on the status information.

According to an aspect of still another exemplary embodiment, there is provided a master node which may include: a reception unit configured to receive status information about a plurality of slave nodes constituting a distributed cluster; and a selection unit configured to select at least one operation node for performing at least one operation to be processed in the distributed cluster based on the status information.

### BRIEF DESCRIPTION OF THE DRAWINGS

The above and other aspects of the exemplary embodiments of the present inventive concept will become more apparent by describing in detail exemplary embodiments thereof with reference to the attached drawings, in which:

FIG. 1 is a schematic diagram of a distributed cluster according to an exemplary embodiment;

FIG. 2A is a schematic diagram for explaining a distributed processing method according to an exemplary embodiment, and FIG. 2B is a timing diagram for explaining the distributed processing method shown in FIG. 2A, according to an exemplary embodiment;

FIG. 3 is a schematic diagram for explaining a sequence of receiving storage status information, according to an exemplary embodiment;

FIGS. 4 to 6 are timing diagrams for explaining a sequence of receiving storage status information, according to exemplary embodiments;

FIGS. 7 and 8 illustrate database tables in which storage status information is stored, according to exemplary embodiments;

FIG. 9 is a schematic diagram for explaining a distributed processing method according to another exemplary embodiment;

FIGS. 10 and 11 are schematic diagrams for explaining distributed processing methods according to other exemplary embodiments;

FIGS. 12 and 13 are histograms for explaining abrasion extents of storages for a plurality of slave nodes, according to exemplary embodiments;

FIG. 14 is a graph for explaining a distribution of slave nodes according to abrasion extents, according to an exemplary embodiment;

FIGS. 15 and 16 are flowcharts for explaining a distributed processing method according to exemplary embodiments;

FIG. 17 is a flowchart for explaining a distributed processing method according to another exemplary embodiment;

FIG. 18 is a schematic block diagram of an electronic system including a semiconductor device according to an exemplary embodiment; and

FIG. 19 is a schematic block diagram for explaining an application example of the electronic system shown in FIG. 18, according to an exemplary embodiment.

### DETAILED DESCRIPTION OF THE EXEMPLARY EMBODIMENTS

The present inventive concept will now be described more fully hereinafter with reference to the accompanying drawings, in which exemplary embodiments of the inventive concept are shown. This inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. The same reference numbers indicate the same components throughout the specification. In the attached figures, the thickness of layers and regions is exaggerated for clarity.

The use of the terms “a” and “an” and “the” and similar referents in the context of describing the inventive concept (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present inventive concept.

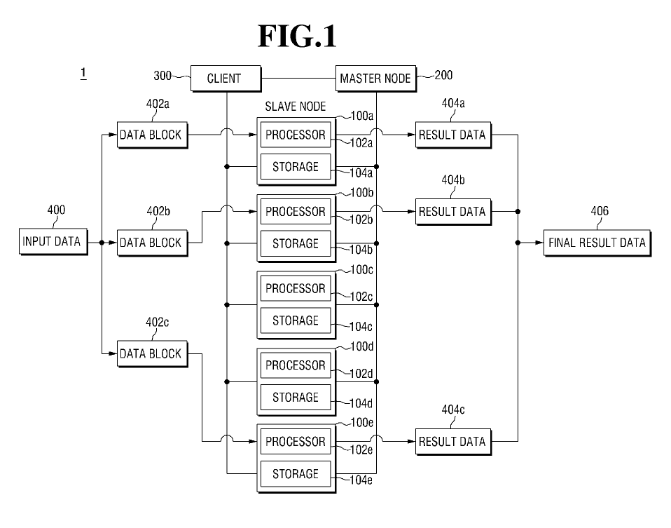

FIG. 1 is a schematic diagram of a distributed cluster according to an exemplary embodiment of the present inventive concept.

Referring to FIG. 1, the distributed cluster 1 according to the embodiment of the present inventive concept may include slave nodes 100a, 100b, 100c, 100d and 100e, a master node 200 and a client 300. According to some embodiments of the present inventive concept, the distributed cluster 1 may be, for example, a Hadoop cluster based on a Hadoop framework.

The slave nodes 100a, 100b, 100c, 100d and 100e may include processors 102a, 102b, 102c, 102d and 102e, and storages 104a, 104b, 104c, 104d and 104e, respectively. The slave nodes 100a, 100b, 100c, 100d and 100e may store input data 400 to be processed by the distributed cluster 1 in the storages 104a, 104b, 104c, 104d and 104e or may process the input data 400 stored using the processors 102a, 102b, 102c, 102d and 102e. For example, the input data 400 is divided into three data blocks 402a, 402b and 402c to then be stored in the storages 104a, 104b and 104e of the slave nodes 100a, 100b and 100e, respectively, and the slave nodes 100a, 100b and 100e process the data blocks 402a, 402b and 402c using the processors 102a, 102b and 102e to obtain result data 404a, 404b and 404c. The result data 404a, 404b and 404c are compiled as final result 406 to then be supplied to, for example, the client 300. In FIG. 1, the distributed cluster 1 according to the embodiment of the present inventive concept including five slave nodes 100a, 100b, 100c, 100d and 100e is exemplified, but the inventive concept does not limit the number of slave nodes to five (5). Rather, an arbitrary number of slave nodes may be provided in the distributed cluster 1 according to the embodiment of the present inventive concept.

The processors 102a, 102b, 102c, 102d and 102e may include at least one central processing unit (CPU) and at least one graphics processing unit (GPU). In addition, in some embodiments of the present inventive concept, the processors 102a, 102b, 102c, 102d and 102e may include a plurality of CPUs and a plurality of GPUs. Meanwhile, in some embodiments of the present inventive concept, the processors may be semiconductor devices, including a field programmable gate array (FPGA). Meanwhile, the storages 104a, 104b, 104c, 104d and 104e may include a hard disk drive (HDD), a solid state drive, SSD) an optical drive such as CD-ROM or DVD-ROM, and so on.

The distributed cluster 1 may include at least one master node 200. The master node 200 may schedule operations processed in the distributed cluster 1 and may manage slave nodes 100a, 100b, 100c, 100d and 100e. For example, the master node 200 may select an operation execution node among the slave nodes 100a, 100b, 100c, 100d and 100e to execute a predetermined operation. Meanwhile, the client 300 may receive an operation command from a user to initiate a request for execution of the operation at the distributed cluster 1 or may offer the result data from the distributed cluster 1 for withdrawal or perusal.

The slave nodes 100a, 100b, 100c, 100d and 100e, the master node 200 and the client 300 may be connected to each other by a network. According to some embodiments of the present inventive concept, the network may be a wireless network including Wi-Fi or a wired network including a local area network (LAN), but aspects of the present inventive concept are not limited thereto.

Meanwhile, according to some embodiments of the present inventive concept, each of the slave nodes 100a, 100b, 100c, 100d and 100e, the master node 200 and the client 300 may be a single server device or a server program. In addition, according to some embodiments of the present inventive concept, at least one of the slave nodes 100a, 100b, 100c, 100d and 100e, the master node 200 and the client 300 may be include in a single server device performing multiple roles or a server program. In particular, the slave nodes 100a, 100b, 100c, 100d and 100e and the master node 200 used in the distributed cluster 1 according to the embodiment of the present inventive concept may be implemented by a rack server.

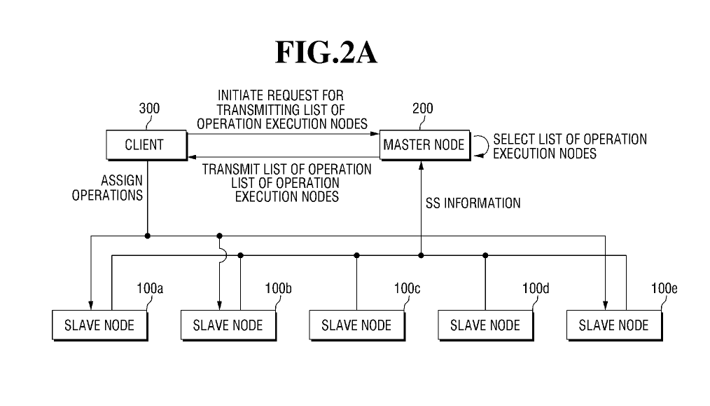

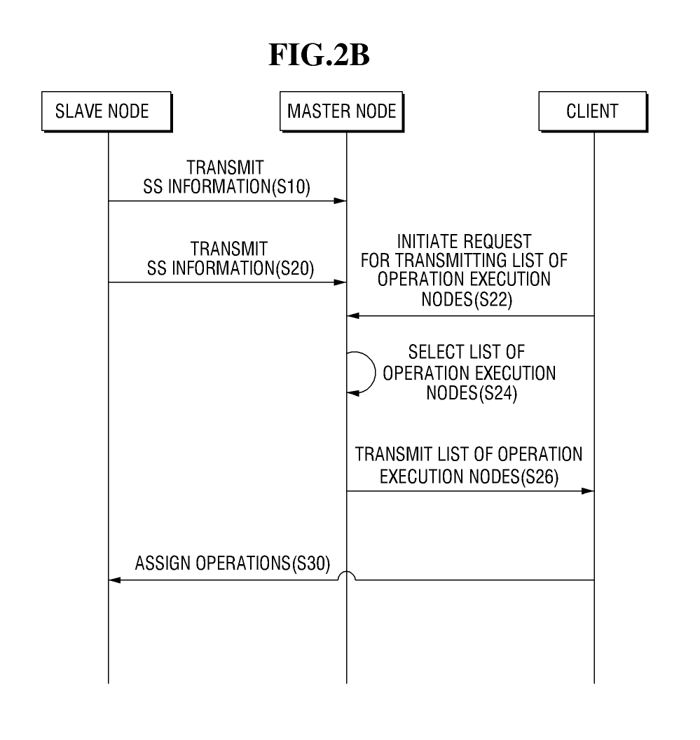

FIG. 2A is a schematic diagram for explaining a distributed processing method according to an exemplary embodiment of the present inventive concept, and FIG. 2B is a timing diagram for explaining the distributed processing method shown in FIG. 2A.

Referring to FIG. 2A, the distributed processing method according to the embodiment of the present inventive concept includes an operation of receiving status information about each of storages 104a, 104b, 104c, 104d and 104e respectively provided in a plurality of slave nodes 100a, 100b, 100c, 100d and 100e constituting a distributed cluster 1 (hereinafter referred to as storage status (SS) information) from the respective slave nodes 100a, 100b, 100c, 100d and 100e, and an operation of selecting operation execution nodes to execute operations processed in the distributed cluster 1 based on the SS information. According to some embodiments of the present inventive concept, for example, the SS information may include self-monitoring, analysis and reporting technology (SMART) attribute information, which can be acquired from a storage including a hard disk drive (HDD) or a solid state drive (SSD). In addition, in some other embodiments of the present inventive concept, the SS information may include intrinsic information concerning a storage manufacturer, which can be transmitted to the master node 200. The intrinsic information concerning a storage manufacturer may include, for example, an abrasion extent, an error rate or a performance level of a storage such as each of the storages 104a, 104b, 104c, 104d and 104e respectively.

Referring to FIG. 2B, the master node 200 may receive the SS information from the plurality of slave nodes 100a, 100b, 100c, 100d and 100e (S10). For this operation, the master node 200 may receive the SS information about each of the storages 104a, 104b, 104c, 104d and 104e provided in the plurality of slave nodes 100a, 100b, 100c, 100d and 100e constituting the distributed cluster 1, from the slave nodes 100a, 100b, 100c, 100d and 100e at a constant time interval. Accordingly, the master node 200 may re-receive the SS information from the plurality of slave nodes 100a, 100b, 100c, 100d and 100e (S20). Next, the client 300 may initiate a request for a list of at least one operation execution node to the master node 200 to execute at least one operation to be processed in the distributed cluster 1 (S22). After receiving the request initiated by the client 300, the master node 200 may select at least one operation execution node to execute the at least one operation to be processed in the distributed cluster 1 based on the received SS information (S24), and may transmit to the client 300 the list of at least one selected operation execution node in response to the request initiated by the client 300 for transmitting the list of at least one operation execution node (S26). Accordingly, the client 300 may assign the at least one operation to at least one of the slave nodes selected by the master node 200.

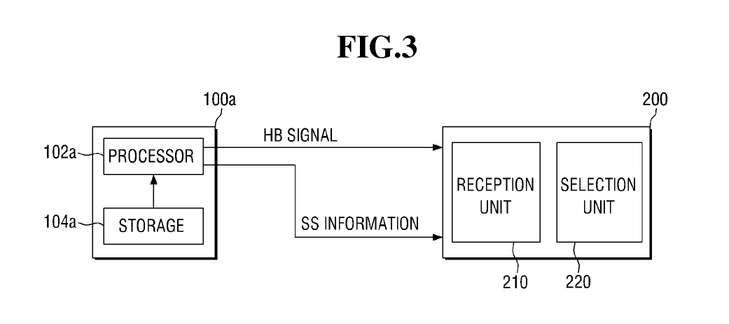

FIG. 3 is a schematic diagram for explaining a sequence of receiving storage status (SS) information.

Referring to FIG. 3, the master node 200 may include a reception unit 210 and a selection unit 220. The reception unit 210 may receive the SS information about each of the storages 104a, 104b, 104c, 104d and 104e provided in the plurality of slave nodes 100a, 100b, 100c, 100d and 100e constituting the distributed cluster 1, from the plurality of slave nodes 100a, 100b, 100c, 100d and 100e. The selection unit 220 may select at least one operation execution node for executing at least one operation processed in the distributed cluster 1 based on the SS information. According to some embodiments of the present inventive concept, the distributed cluster 1 may be a Hadoop cluster based on a Hadoop framework, and the SS information may be received together with a heartbeat (HB) signal provided from the Hadoop cluster. The HB signal refers to a signal periodically transmitted and/or received between the master node and the slave nodes in the Hadoop cluster. For example, the master node and the slave nodes may identify connection states thereof by transmitting and/or receiving the HB signal at an interval of three (3) seconds. The HB signal may also include a position and status information about each of data blocks stored in a Hadoop distributed file system (HDFS) or progress status information about each of operation tasks processed in the Hadoop cluster.

According to an exemplary embodiment of the present inventive concept, the reception unit 210 and the selection unit 220 may embodied as the various numbers of hardware, software and/or firmware structures that execute the respective functions described above. For example, the reception unit 210 and the selection unit 220 may use a direct circuit structure, such as a memory, processing, logic, a look-up table, etc. that may execute the respective functions through controls of one or more microprocessors or other control apparatuses. The reception unit 210 and the selection unit 220 may be specifically embodied by a module, a program, or a part of code, which contains one or more executable instructions for performing specified logic functions.

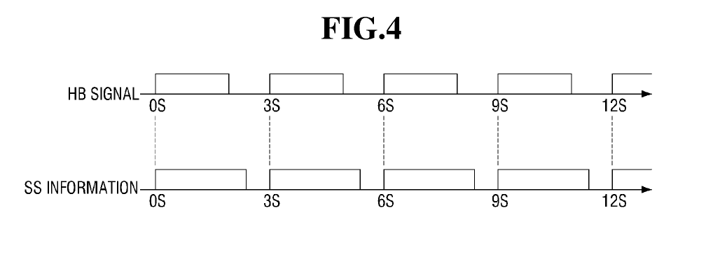

FIGS. 4 to 6 are timing diagrams for explaining a sequence of receiving storage status information.

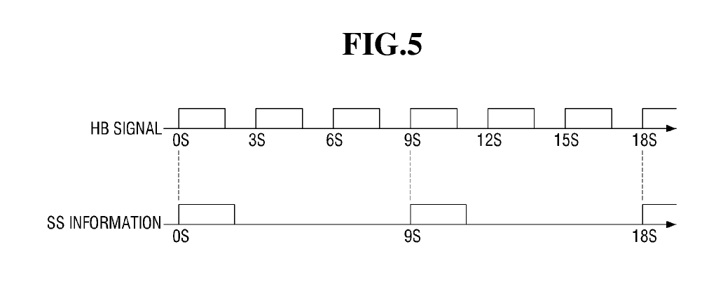

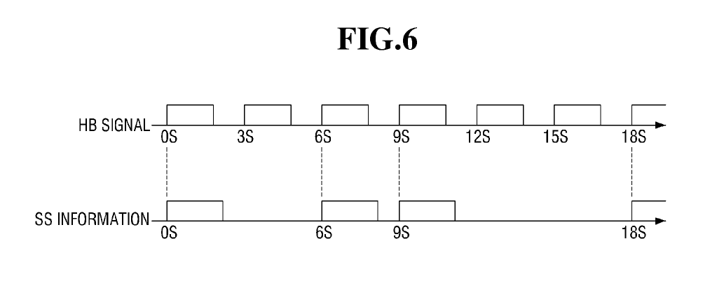

The master node 200 receiving the SS information from the plurality of slave nodes 100a, 100b, 100c, 100d and 100e may include receiving the SS signal at an interval of one hour based on the period of the HB signal provided from the Hadoop cluster. Referring to FIG. 4, the master node 200 may receive the HB signal at an interval of three (3) seconds and may receive the SS information at an interval based on the period of the HB signal, that is, at a three (3) second interval. Alternatively, according to some embodiments of the present inventive concept, referring to FIG. 5, the master node 200 may receive the HB signal at an interval of three (3) seconds and may receive the SS information at an interval of three (3) times the period of the HB signal, that is, at a nine (9) second interval. Meanwhile, according to some embodiments of the present inventive concept, referring to FIG. 6, the master node 200 may receive the SS information together with the HB signal. Specifically, the master node 200 may receive the SS information at an irregular interval, for example, at intervals of six (6) seconds, three (3) seconds and nine (9) seconds.

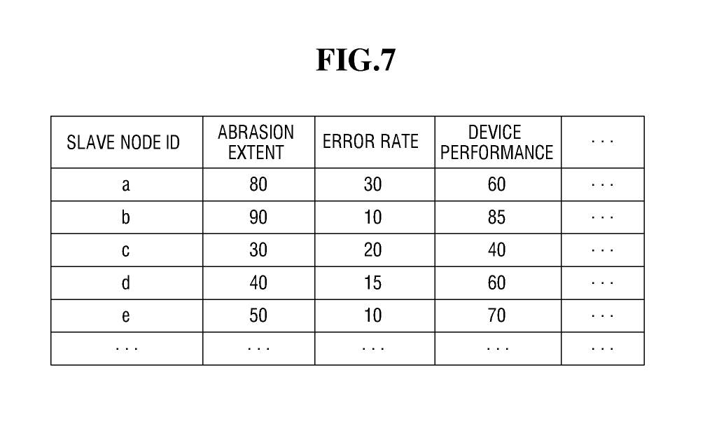

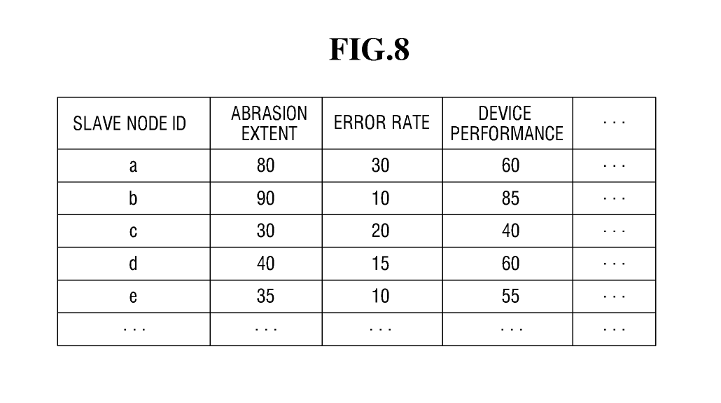

FIGS. 7 and 8 illustrate database tables in which storage status (SS) information is stored.

In order to select operation execution nodes for executing operations processed in the distributed cluster 1 in response to a request initiated by the client 300, the master node 200 may store and manage SS information about each of the storages 104a, 104b, 104c, 104d and 104e in database tables. This SS information may be received from the plurality of slave nodes 100a, 100b, 100c, 100d and 100e. For example, the table may include columns indicating IDs of slave nodes, abrasion extents of storages, error rates of storages, and device performance levels of storages. Referring to FIG. 7, the table includes records of (a, 80, 30, 60), (b, 90, 10, 85), (c, 30, 20, 40), (d, 40, 15, 60), and (e, 50, 10, 70). That is, the record corresponding to a first row indicates an identifier (ID) of a slave node, an abrasion extent of a storage provided in the slave node, an error rate and a device performance level being ‘a’, ‘80’, ‘30’, and ‘60’, respectively. The numerical values may be values intrinsically determined for the storages 104a, 104b, 104c, 104d and 104e (for example, an error rate of 30%), or relative values for comparison with other storages (for example, device performance level of approximately 60, which is evaluated on the assumption that the performance level of a particular storage is 100).

In the distributed processing method according to the embodiment of the present inventive concept, when the master node 200 may receive the SS information about each of the storages 104a, 104b, 104c, 104d and 104e provided in the plurality of slave nodes 100a, 100b, 100c, 100d and 100e constituting the distributed cluster 1, from the slave nodes 100a, 100b, 100c, 100d and 100e, the SS information may include information concerning abrasion extents of the respective storages 104a, 104b, 104c, 104d and 104e, and data blocks to be processed in the distributed cluster 1 may be stored in the slave nodes 100a, 100b and 100e having low abrasion extents. The SS information may include information concerning error rates of the respective storages 104a, 104b, 104c, 104d and 104e, and data blocks to be processed in the distributed cluster 1 may be stored in the slave nodes 100b, 100d and 100e having low error rates.

In addition, in the distributed processing method according to the embodiment of the present inventive concept, when the master node 200 may receive the SS information about each of the storages 104a, 104b, 104c, 104d and 104e provided in the plurality of slave nodes 100a, 100b, 100c, 100d and 100e constituting the distributed cluster 1, from the slave nodes 100a, 100b, 100c, 100d and 100e, the SS information may include information concerning performance levels of the storages 104a, 104b, 104c, 104d and 104e, and data blocks may be stored in the slave nodes 100a, 100b and 100e having high performance levels being processed.

Next, referring to FIG. 8, the master node 200 may re-receive the SS information about each of the storages 104a, 104b, 104c, 104d and 104e from the plurality of slave nodes 100a, 100b, 100c, 100d and 100e, and may update a database table. The record corresponding to a fifth row indicates an ID of a slave node, an abrasion extent of a storage provided in the slave node, an error rate and a device performance level being ‘e’, ‘35’, ‘10’, and ‘55’, respectively. Accordingly, since there is a change in the SS information, the master node 200 may reselect operation execution nodes in response to a request initiated by the client 300 for transmitting a list of operation execution nodes and may transmit the list of newly selected operation execution nodes to the client 300.

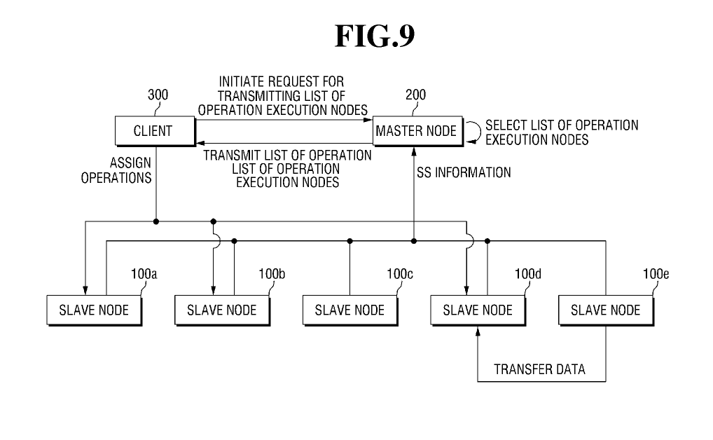

FIG. 9 is a schematic diagram for explaining a distributed processing method according to another exemplary embodiment of the present inventive concept.

Referring to FIG. 9 with FIG. 8, in the distributed processing method according to another exemplary embodiment of the present inventive concept, when the master node 200 may re-receive SS information about each of the storages 104a, 104b, 104c, 104d and 104e provided in the plurality of slave nodes 100a, 100b, 100c, 100d and 100e constituting the distributed cluster 1, from the slave nodes 100a, 100b, 100c, 100d and 100e, the SS information may include information concerning abrasion extents of the respective storages 104a, 104b, 104c, 104d and 104e. Since the abrasion level of the slave node 100e becomes higher than that of the slave node 100d, the data block stored in the slave node 100e may be transferred to the slave node 100d.

In the distributed processing method according to another exemplary embodiment of the present inventive concept, when the master node 200 may re-receive SS information for each of the storages 104a, 104b, 104c, 104d and 104e provided in the plurality of slave nodes 100a, 100b, 100c, 100d and 100e constituting the distributed cluster 1 from the slave nodes 100a, 100b, 100c, 100d and 100e, the SS information may include information concerning device performance levels of the respective storages 104a, 104b, 104c, 104d and 104e. Since the performance level of the slave node 100d becomes higher than that of the slave node 100e, the data block stored in the slave node 100d, instead of the data block stored in the slave node 100e, may be processed.

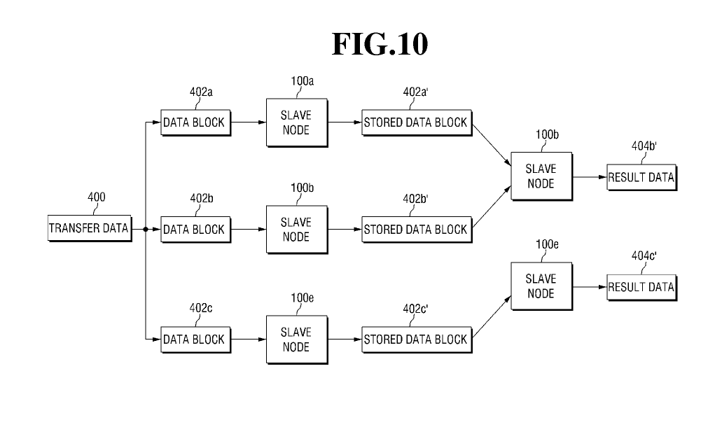

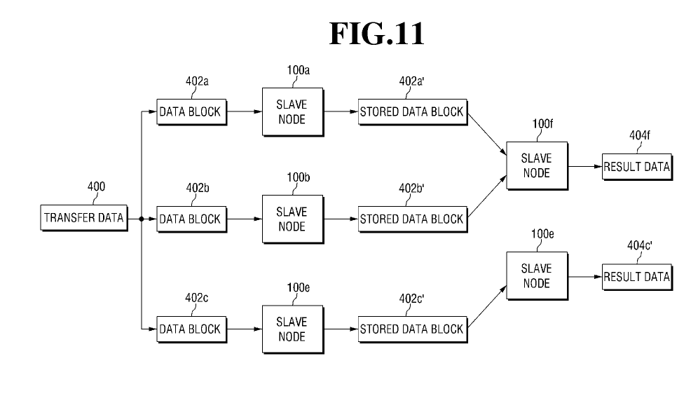

FIGS. 10 and 11 are schematic diagrams for explaining distributed processing methods according to other exemplary embodiments of the present inventive concept.

Referring to FIG. 10, input data 400 may be divided into data blocks 400a, 400b and 400c to then be stored in the slave nodes 100a, 100b and 100e selected by the master node 200 as stored data blocks 402a′, 402b′ and 402c′, respectively. The stored data blocks 402a′, 402b′ and 402c′ may be processed by the slave nodes 100a, 100b and 100e. However, in the distributed processing method according to still another exemplary embodiment of the present inventive concept, if the operation executing performance or stability of the slave node 100a by the re-received SS information is noticeably reduced, the stored data block 402a′ stored in the slave node 100a may be processed by the slave node 100b instead of the slave node 100a. In addition, referring to FIG. 11, in the distributed processing method according to still another exemplary embodiment of the present inventive concept, if the performance level of the slave node 100f is much higher than the performance levels of the slave nodes 100a and 100b storing the stored data blocks 402a′ and 402b′, the stored data blocks 402a′ and 402b′ stored in the slave nodes 100a and 100b may be processed by the slave node 100f instead of the slave nodes 100a and 100b.

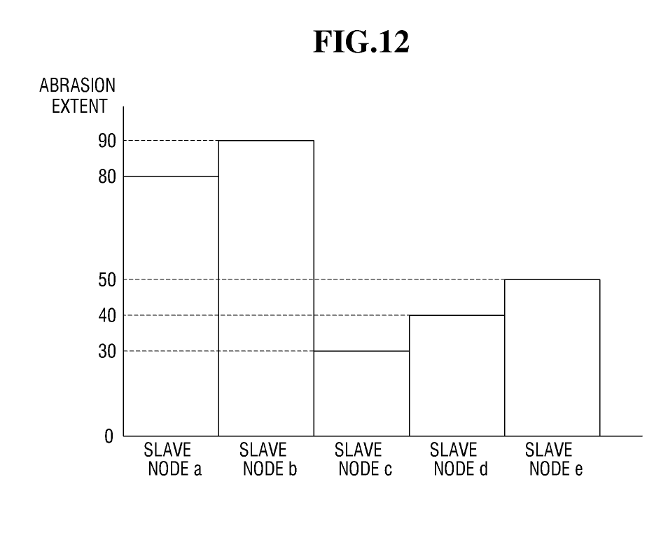

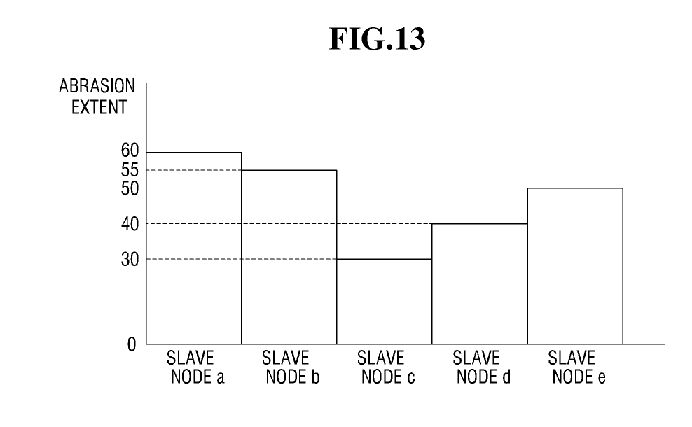

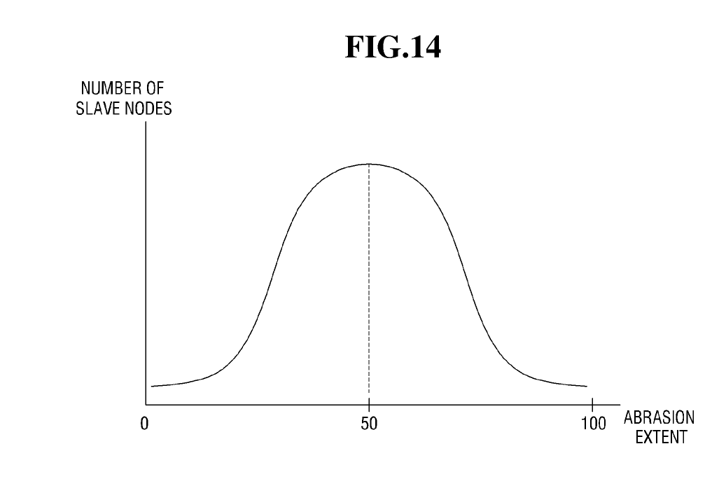

FIGS. 12 and 13 are histograms for explaining abrasion extents of storages for a plurality of slave nodes according to exemplary embodiments, and FIG. 14 is a graph for explaining a distribution of slave nodes according to abrasion extents according to an exemplary embodiment.

Referring to FIGS. 12 and 13, the histograms illustrate that distributed processing methods according to various exemplary embodiments of the present inventive concept can prevent abrasion of some slave nodes from being accelerated. Data blocks may be stored in the save nodes 100a and 100b having relatively low abrasion extents, i.e., 80 and 90, among the plurality of slave nodes 100a, 100b, 100c, 100d and 100e constituting the distributed cluster 1, or the amount of operations for processing the stored data blocks may be increased while reducing the amount of operations for the slave nodes 100c, 100d and 100e having relatively high abrasion extents, i.e., 30, 40 and 50, thereby relatively uniformly maintaining the overall abrasion extents of the plurality of slave nodes 100a, 100b, 100c, 100d and 100e constituting the distributed cluster 1 and preventing abrasion of a particular slave node from being accelerated. Referring to FIG. 14, the above-described procedure may be repeated to make the number of slave nodes according to abrasion extents establish a substantially normal distribution, thereby improving stability of the overall distributed cluster 1.

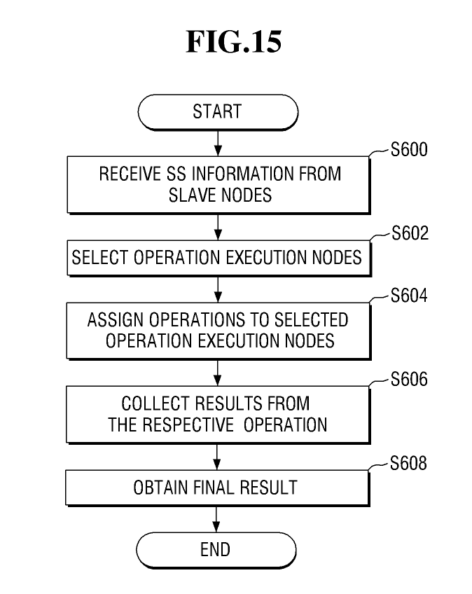

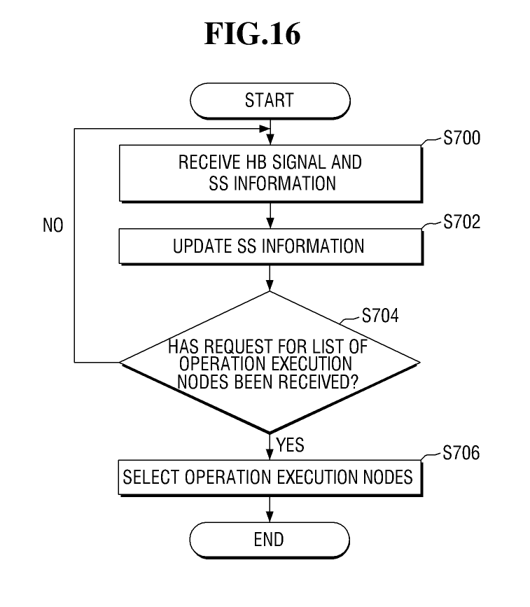

FIGS. 15 and 16 are flowcharts for explaining a distributed processing method according to an exemplary embodiment of the present inventive concept.

Referring to FIG. 15, in the distributed processing method according to the embodiment of the present inventive concept, the master node 200 may receive SS information about each of the storages 104a, 104b, 104c, 104d and 104e provided in the plurality of slave nodes 100a, 100b, 100c, 100d and 100e constituting the distributed cluster 1, from the slave nodes 100a, 100b, 100c, 100d and 100e (S600). The master node 200 may select operation execution nodes for executing operations processed in the distributed cluster 1 based on the received SS information (S602). Next, the master node 200 may assign operations to the selected operation execution nodes by transmitting a list of the selected operation execution nodes to the client 300 in response to a request initiated by the client 300 for transmitting the list of operation execution nodes (S604). If the processing of the operations is completed, the master node 200 or the client 300 collects results from the respective operation execution nodes (S606), and a final result is obtained to be transmitted to, for example, a user (S608).

Referring to FIG. 16, the distributed cluster 1 may be a Hadoop cluster constructed based on a Hadoop framework, and the receiving of the SS information may include receiving the SS information with a heartbeat (HB) signal provided from the Hadoop cluster (S700). The master node 200 may update new SS information in the self-managed table based on the periodically received SS information (S702). While repeating the above-described procedure, the master node 200 checks whether a request for a list of operation execution nodes has been received from the client 300 (S704). If yes, operation execution nodes are selected based on the re-received SS information (S706), and the list is transmitted to the client 300.

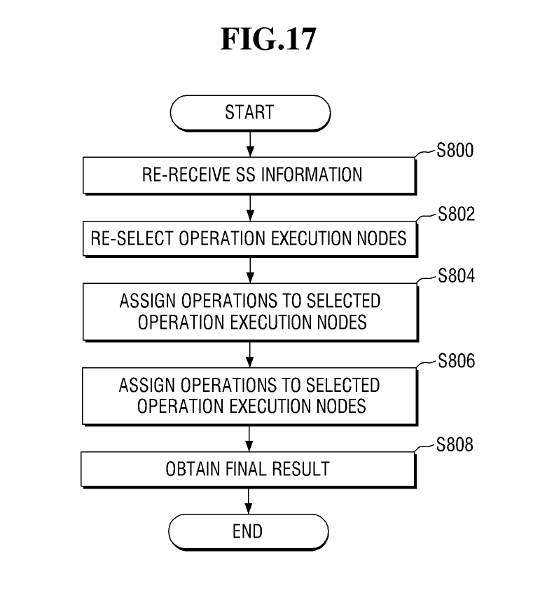

FIG. 17 is a flowchart for explaining a distributed processing method according to another exemplary embodiment of the present inventive concept.

Referring to FIG. 17, in the distributed processing method according to another embodiment of the present inventive concept, the master node 200 may periodically re-receive SS information about each of the storages 104a, 104b, 104c, 104d and 104e provided in the plurality of slave nodes 100a, 100b, 100c, 100d and 100e constituting the distributed cluster 1, from the slave nodes 100a, 100b, 100c, 100d and 100e (S800). The master node 200 may re-select operation execution nodes for executing operations processed in the distributed cluster 1 based on the received new SS information (S802). Next, the master node 200 or the client 300 may transfer the data blocks or the operations from the operation execution nodes in which data blocks are stored or to which operations for processing data blocks are assigned to the re-selected operation execution nodes, based on the list of re-selected operation execution nodes (S804). If the processing of the operations is completed, the master node 200 or the client 300 collects results from the respective operation execution nodes (S806), and a final result is obtained to be transmitted to, for example, a user (S808).

According to the present inventive concept, data can be efficiently processed in a distributed cluster and stability of data can be secured. In detail, if an abrasion extent of a first storage provided in a first slave node is lower than that of a second storage provided in a second slave node, data block is stored in the first slave node, thereby stably storing the data block. If a performance level of the first storage is higher than that of the second storage, data stored in the first node may be processed, thereby improving the data processing speed.

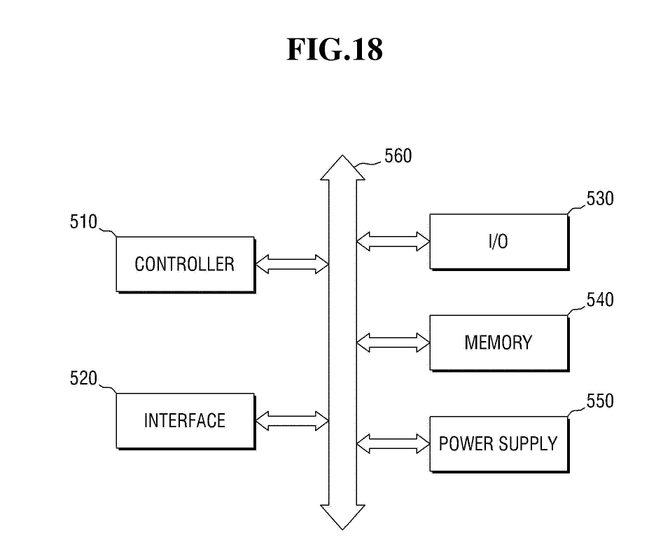

Hereinafter, an electronic system by which distributed processing methods according to some embodiments of the present inventive concept will be described. FIG. 18 is a schematic block diagram of an electronic system including a semiconductor device according to an exemplary embodiment of the present inventive concept.

Referring to FIG. 18, the electronic system may include a controller 510, an interface 520, an input/output device (I/O) 530, a memory 540, a power supply 550, and a bus 560.

The controller 510, the interface 520, the I/O 530, the memory 540, and/or the power supply 550 may be connected to each other through the bus 560. The bus 560 corresponds to a path through which data moves.

The controller 510 may include at least one of a microprocessor, a digital signal processor, a microcontroller, and logic elements capable of functions similar to those of these elements.

The interface 520 may perform functions of transmitting data to a communication network or receiving data from the communication network. The interface 520 may be wired or wireless. For example, the interface 520 may include an antenna or a wired/wireless transceiver, and so on.

The I/O 530 may include a keypad, a display device, and so on.

The memory 540 may store data and/or commands. The semiconductor devices according to some embodiments of the present inventive concept may be provided some components of the memory 540.

The power supply 550 may convert externally input power and may provide the converted power to the respective components 510 to 540.

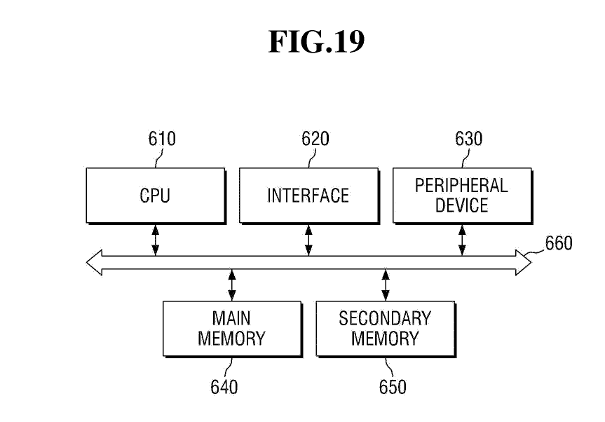

FIG. 19 is a schematic block diagram for explaining an application example of the electronic system shown in FIG. 18, according to an exemplary embodiment.

Referring to FIG. 19, the exemplary electronic system may include a central processing unit (CPU) 610, an interface 620, a peripheral device 630, a main memory 640, a secondary memory 650, and a bus 660.

The CPU 610, the interface 620, the peripheral device 630, the main memory 640 and the secondary memory 650 may be connected to each other through the bus 660. The bus 660 corresponds to a path through which data moves.

The CPU 610, including a controller, an operation unit, etc., may execute a program and may process data.

The interface 620 may perform functions of transmitting data to a communication network or receiving data from the communication network. The interface 620 may be wired or wireless. For example, the interface 620 may include an antenna or a wired/wireless transceiver, and so on.

The peripheral device 630, including a mouse, a keyboard, a display device, and a printer, may input/output data.

The main memory 640 may transmit/receive data to/from the CPU 610 and may store data and/or commands necessary for executing a program. The semiconductor devices according to some embodiments of the present inventive concept may be provided some components of the main memory 640.

The secondary memory 650, including a nonvolatile memory, such as a magnetic tape, a magnetic disk, a floppy disk, a hard disk, an optical disk, etc., may store data and/or commands. The secondary memory 650 may store data even when the power of the electronic system is interrupted.

In addition, the electronic system for implementing distributed processing methods according to some embodiments of the present inventive concept, may be implemented as a computer, an ultra-mobile personal computer (UMPC), a work station, a net-book, a personal digital assistant (PDA), a portable computer, a web tablet, a wireless phone, a mobile phone, a smart phone, an e-book, a portable multimedia player (PMP), a portable game console, a navigation device, a black box, a digital camera, a three (3) dimensional television, a digital audio recorder, a digital audio player, a digital picture recorder, a digital picture player, digital video recorder, a digital video player, a device capable of transmitting/receiving information in wireless environments, one of various electronic devices constituting a home network, one of various electronic devices constituting a computer network, one of various electronic devices constituting a telematics network, RFID devices, or embedded computing systems, and so on.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims. It is therefore desired that the present embodiments be considered in all respects as illustrative and not restrictive, reference being made to the appended claims rather than the foregoing description to indicate the scope of the inventive concept.

What is claimed is:

1. A data processing method comprising:
receiving status information about a plurality of storages respectively provided in a plurality of slave nodes constituting a distributed cluster; and
selecting at least one operation node, among the plurality of slave nodes, for performing at least one operation to be processed in the distributed cluster based on the status information.

2. The data processing method of claim 1, wherein the receiving status information about storages comprises receiving the status information from the plurality of slave nodes, at a constant time interval.

3. The data processing method of claim 1, wherein the distributed cluster includes a Hadoop cluster constructed based on a Hadoop framework, and
wherein the receiving status information about storages comprises receiving the status information along with a heartbeat signal provided from the Hadoop cluster.

4. The data processing method of claim 3, wherein the heartbeat signal comprises information about at least one of position and status information about each of data blocks stored in the plurality of slave nodes and progress status information about each of operation tasks processed in the Hadoop cluster.

5. The data processing method of claim 3, wherein the receiving status information about storages comprises receiving the status information at an interval based on a period of the heartbeat signal provided from the Hadoop cluster.

6. The data processing method of claim 1, wherein the status information about storages includes self-monitoring, analysis and reporting technology (SMART) attribute information.

7. The data processing method of claim 1, wherein the status information about the plurality of storages includes information concerning at least one of abrasion extents of the storages, error rates of the storages and performance levels of the plurality of storages.

8. The data processing method of claim 1, further comprising transmitting a list of the selected at least one operation node to a client in response to a request initiated by the client for transmitting the list.

9. The data processing method of claim 1, if there is a change in the status information about the plurality of storages, further comprising re-selecting at least one operation node among the plurality of slave nodes.

10. The data processing method of claim 9, further comprising transferring the at least one operation to the re-selected at least one operation node.

11. The data processing method of claim 1, wherein the at least one operation to be processed in the distributed cluster includes an operation of storing at least one data block in the selected at least one node and an operation of processing the at least one data block.

12. The data processing method of claim 1, wherein the receiving the status information and the selecting at least one operation node are performed at a master node, and
wherein the master node and the slave nodes are included in a single server or a single server program.

13. A data processing method comprising:
receiving status information about a plurality of nodes constituting a distributed cluster, the status information including at least one of an abrasion extent, a performance level and an error rate of the plurality of nodes; and
selecting at least one node among the plurality of nodes for performing at least one operation to be processed in the distributed cluster based on the status information.

14. The data processing method of claim 13, further comprising controlling a data block, scheduled to be stored in a first node among the plurality of nodes, to be stored in a second node among the plurality of nodes, if at least one of the abrasion extents of the first node and the second node is within a predetermined range.

15. The data processing method of claim 14, further comprising:
re-receiving at least one of the status information about the first node and the status information about the second node; and
transferring the data block stored in the second node to the first node, if at least one of the abrasion extents of the first node and the second node has changed by a predetermined amount.

16. The data processing method of claim 13, further comprising:
controlling first data stored in a first node, instead of second data stored in a second node, among the plurality of nodes to be processed in the distributed cluster, if at least one of the performance levels of the first node and the second node is within a predetermined range.

17. The data processing method of claim 13, further comprising:
re-receiving at least one of the status information about the first node and the status information about the second node; and
controlling the second data stored in the second node, instead of the data stored in the first node, to be processed in the distributed cluster, if at least one of the performance levels of the first node and the second node has changed by a predetermined amount.

18. The data processing method of claim 13, further comprising:
controlling a first node among the plurality of nodes to process data stored in at least one of other nodes among the plurality of nodes, if the performance level of the first node is higher than the performance levels of the other nodes.

19. A master node comprising:
a reception unit configured to receive status information about a plurality of slave nodes constituting a distributed cluster; and
a selection unit configured to select at least one operation node for performing at least one operation to be processed in the distributed cluster based on the status information.

20. The master node of claim 19, wherein the reception unit is configured to receive the status information about the slave nodes constituting the distributed cluster, from the slave nodes, at a constant time interval.
